(19) United States
(12) Patent Application Publication
(10) Pub. No.: US 2015/0227884 A1
(43) Pub. Date: Aug. 13, 2015

(54) RANGED ITEM INDICATOR

(71) Applicant: ORACLE INTERNATIONAL CORPORATION, Redwood Shores, CA (US)

(72) Inventors: Chad Jeffrey TIMM, Minneapolis, MN (US); Amy Jane SELBY, Falcon Heights, MN (US); Vaibhav DIKSHIT, Plano, TX (US); Pankaj BISEN, Bangalore (IN)

(21) Appl. No.: 14/175,075

(22) Filed: Feb. 7, 2014

(51) Int. Cl. G06Q 10/08

(52) U.S. Cl. CPC G06Q 10/087

(57) ABSTRACT

Systems, methods, and other embodiments associated with ranged item indicators are described. In one embodiment, a method includes identifying a transaction associated with an item and a location. The item has an indicator. The value of the indicator describes a range relationship between the item and the location. When the indicator has a value of incidental, the item is not stocked by the location. When the indicator has a value of intentional, the item is stocked by the location. The indicator of the item is not set when a range relationship has not been established between the item and the location. The method also includes determining if the transaction has been labeled as incidental or intentional when the indicator of the item has not been set. The method includes setting the value for the indicator of the item to the label of the transaction.

### BACKGROUND

Retail assortment decisions have become increasingly complicated. Complications arise when retailers attempt to differentiate themselves by offering localized product assortments based on the retail location, demographics, climate, and other factors. Items that are present in a retail location as a result of explicit decisions about what items to carry in a retail location's assortment (e.g., inventory) are referred to as intentionally ranged items because the decision to carry the item is made with intent. Other items may end up in a retail location's assortment through various non-intentional means. For example, a customer may return an item to a store where the item is not normally carried or an item may be transferred to a store where the item is not intended to be received. Non-intentional items that are not ranged to the retail location are referred to as incidental items.

Incidental items are not planned to be carried in the particular retail location. Therefore, key factors, such as price, in-store placement, purchasing plans, and margin targets are not considered for incidental items. Accordingly, accepting an incidental item gives rise to a number of issues like selling an item at a low margin or inadvertently replenishing the item into a location where it was not intended to be sold. Additionally, accepting an incidental item may establish a poor customer experience in the store, for example, by selling a heavy winter coat at a premium price in a retail location having a warm climate.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments one element may be designed as multiple elements or that multiple elements may be designed as one element. In some embodiments, an element shown as an internal component of another element may be implemented as an external component and vice versa. Furthermore, elements may not be drawn to scale.

FIG. 1 illustrates one embodiment of a method associated with a ranged item indicator.

FIG. 2 illustrates one embodiment of a method that generates a list of labeled transactions.

FIG. 3 illustrates another embodiment of a method associated with a ranged item indicator including determining whether an item is ranged to a location.

FIG. 4 illustrates an embodiment of an apparatus associated with a ranged item indicator.

FIG. 5 illustrates one embodiment of an apparatus associated with a ranged item indicator having a prompt logic.

FIG. 6 illustrates one embodiment of an apparatus associated with a ranged item indicator having a relationship logic.

FIG. 7 illustrates one embodiment of an apparatus associated with a ranged item indicator having an analysis logic.

FIG. 8 illustrates an example computing device that is configured and/or programmed to utilize one or more ranged item indicators.

### DETAILED DESCRIPTION

Retailers have difficulty identifying which items are intentionally placed in a retail location's assortment versus which items are incidentally placed in the retail location's assortment. The difficulty arises because items are not clearly identified as being intentional or incidental in an operational data system, such as a retail merchandising system. Thus, retailers have to compare the retail assortment plan to data about what is actually in the retail location in order to identify outliers in the assortment as incidental items.

Apparatuses and methods are described herein that provide an indicator that makes an item identifiable within an operational system as either intentionally or incidentally ranged to a given location. Thus, the value of the indicator represents a relationship of the item to the location. The indicator may either be unset or ranged. If the indicator is ranged, then the indicator has a value of either intentional or incidental to indicate whether an item associated with the indicator is incidentally or intentionally located at the given location.

If an explicit assortment decision has been made to include an item at a location, a transaction to include that item results in the indicator associated with the item being automatically set as intentional. For example, an explicit assortment decision may be made to carry an item at a location. When a transaction occurs importing that item to the location, the indicator associated with the item is set as intentional. Conversely, a transaction for an item where an explicit assortment decision has not been made will result in the indicator associated with the item being automatically set as incidental. Examples of transactions resulting in the indicator being set to incidental include processing sales and returns for an item at an unintended location or the receipt of an unintended transfer or purchase order. The value of the indicator may also be set manually by a user interacting with the operational system.

The indicator is stored as a value in electronic storage (e.g., memory). The system will maintain the value of the stored indicator so that the value for a subsequent item is set with the same value as earlier received instances of that item at the location. However, the value of the indicator may be updated or changed. In one embodiment the indicator may be updated or changed based on the type of transaction occurring for the item. In another embodiment, an indicator for an item that is set as incidental may be updated to intentional to reflect future operations and plans.

The indicator explicitly identifies whether an item belongs in a retail location's assortment. Thus, the indicator reduces the necessity of manual comparison and research that has to be conducted day to day in order to determine whether items at a retail location belong in the retail location's assortment. Operational and analytical reports can be easily generated using the indicator. Incidental items can be filtered out of the analysis of retail plans so the results are not skewed by the unintentional items. Thus, using the indicator results in more accurate results because the incidental items can be excluded from retail plans.

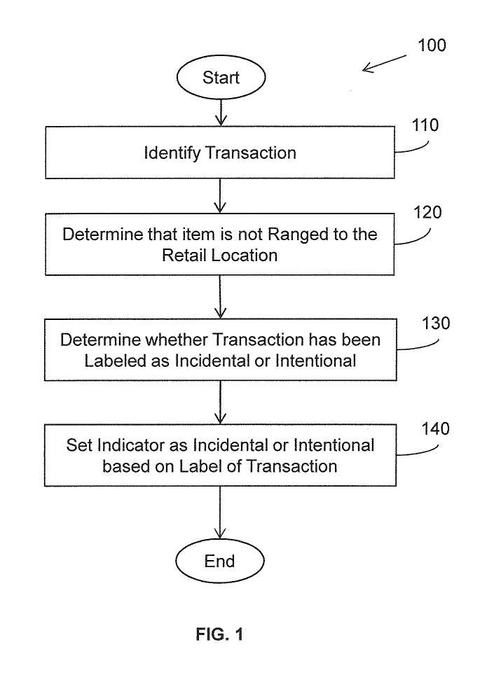

With reference to FIG. 1, one embodiment of a method 100 that sets a value for an indicator is illustrated. The method 100 is performed when an item's indicator has not been set. Method 100, as described, is employed by or operated in conjunction with a retail merchandising system. The retail merchandising system may have access to integration interfaces (e.g., a Point of Sale (POS) interface, maintenance interface, shipping interface) that gather data on retail items and transactions occurring in the retail merchandising system.

At 110, the method identifies a transaction being processed for at least one item at a specific retail location. The transaction may be identified based on the interface used to process the transaction. For example, if the process is initiated at a POS, the transaction may be identified as a return of the item at the specific retail store. Conversely, if the process is initiated at a shipping interface, the transaction may be identified as a transfer.

At 120, it is determined that the item is not ranged for the retail location. For the purposes of this description, an item is considered ranged for a retail location when an indicator for the item has been set as incidental or intentional. Therefore, at 120, it is determined that an indicator for the item has not been previously set as intentional or incidental for this retail location. If the item has not been ranged for the location, it is generally because the item does not have an established range relationship with the location. For example, the item may not have been carried in the assortment of the location. Therefore, a range relationship does not exist for the item at this location.

At 130 it is determined whether the transaction identified at 110 has been labeled as incidental or intentional. A transaction may be labeled as intentional if the transaction causes an item to be introduced into a retail assortment that is intended to carry the item. Alternatively, a transaction may be labeled as incidental if the transaction causes an item to be introduced into a retail assortment of a location that is not intended to carry the item. At 140, the value of the item's indicator is set as intentional or incidental based on the label of the transaction. For example, if the transaction is labeled as incidental, the indicator is set as incidental.

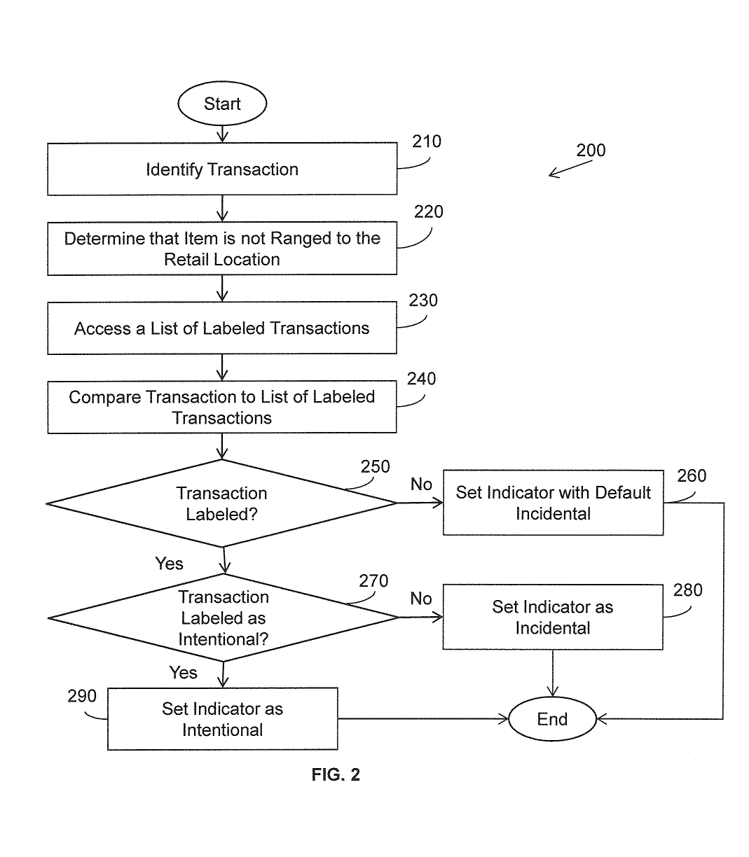

With reference to FIG. 2, one embodiment of a method 200 that generated a list of labeled transactions. At 210, the method includes identifying a transaction occurring at a retail location. The transaction is identified in a similar manner as described with respect to FIG. 1. At 220 it is determined that an indicator for the item has not been previously set as intentional or incidental for this retail location also as described above with respect to FIG. 1.

At 230 a list of labeled transactions is accessed. In the list of labeled transactions, the transactions are labeled as incidental or intentional. As discussed above, a transaction is intentional if the item that is the subject of the transaction is intended to be included in the retail location's assortment. Examples of transactions labeled as intentional may include an on-line purchase order, external purchase order, on-line transfer inbound, external transfer inbound, or online manual item. Also as discussed above, a transaction is incidental if the item that is the subject of the transaction is not intended to be included in the retail location's assortment. Examples of transactions labeled as incidental may include the return of the item to a location that does not carry that item, unexpected receipt of an item on transfer, unexpected receipt of the item on a purchase order, unexpected receipt of the item on allocation, purchase order established in-store, or a transfer established in store or warehouse systems.

At 240, the identified transaction is compared to the list of transactions to determine if a similar transaction has been labeled as intentional or incidental. At 250, it is determined whether the identified transaction is labeled in the list of transactions. If it is determined that the transaction is not labeled, then, at 260, the indicator is set as incidental as a default value for unlabeled transactions. Conversely, if the transaction is labeled, it is determined, at 270, if the transaction is labeled as intentional.

If the transaction is not labeled as intentional, then the indicator is set as incidental at 280. By virtue of setting the indicator as incidental at 280, a range relationship is established for the item at that location that determines that the item is an incidental item at the location. Accordingly, when the item is received at the location in the future, the indicator for the item will already be set to incidental.

If the transaction is labeled as intentional, then the indicator is set as intentional at 290. By virtue of setting the indicator as intentional at 290, a range relationship is established for the item at that location that determines that the item is an intentional item at the location. Accordingly, when the item is received at the location in the future, an indicator for the item will already be set to intentional.

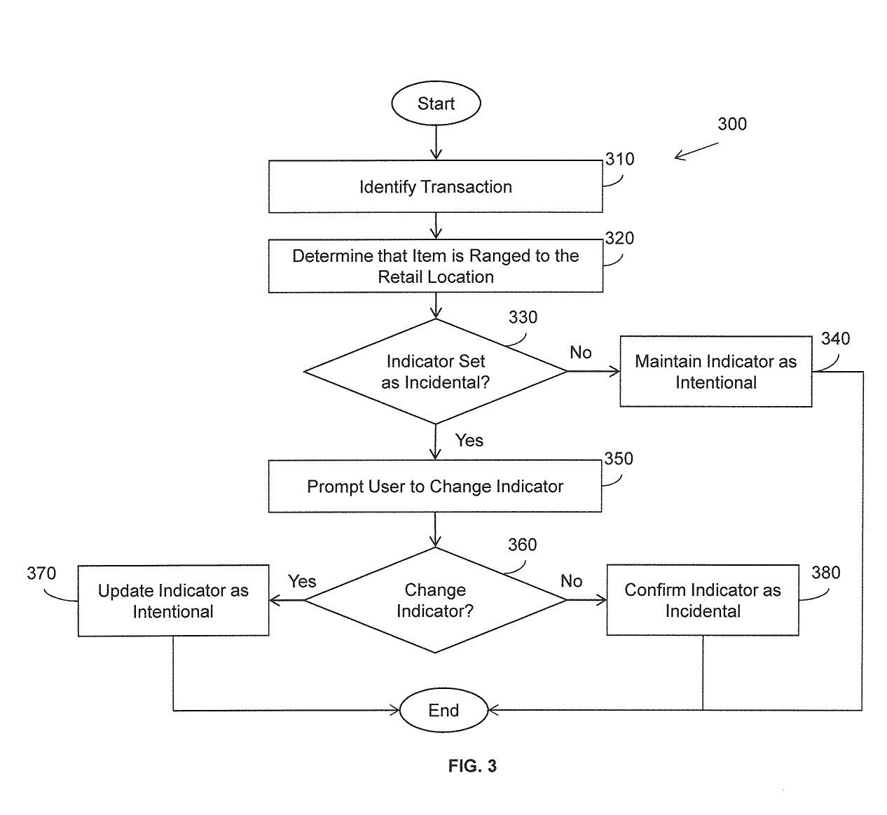

FIG. 3 illustrates another embodiment of a method that sets a value for an indicator based on a user manually confirming or changing the indicator's value. The method 300 is performed when an item's indicator is already set for a location. At 310, the method 300 identifies a transaction being processed for at least one item at a specific retail location in a similar manner as discussed above with respect to FIG. 2. At 320, it is determined that the item is ranged to the retail location. Therefore, as discussed above, it is determined whether the indicator for the item has been previously set as intentional or incidental for this specific retail location.

At 330, it is determined whether the item has an indicator that is set as incidental. If the indicator for the item is not currently set as incidental, the value of the indicator is maintained as intentional at 340. Alternatively, the indicator may have been set as incidental based on a previously established range relationship for the item. For example, this retail location may have previously received this item or an instance of this item via an incidental transaction (e.g., return of item at a location that does not carry the item, unexpected receipt of item in a transfer). If it is determined at 330 that the indicator is set as incidental, a user is prompted to change the indicator, if desired, at 350.

If, at 360, the user updates the value of the indicator to intentional, at 370 the indicator of the item is change to intentional. The user may update the indicator to intentional if the user wishes to create an intentional range relationship for this item at this location because the user anticipates regularly receiving this item. If the user does not change the value of the indicator at 360, at 380 the indicator of the item is maintained as incidental. The user may confirm the indicator as incidental if, for example, the user does not wish to carry the item in the location's assortment.

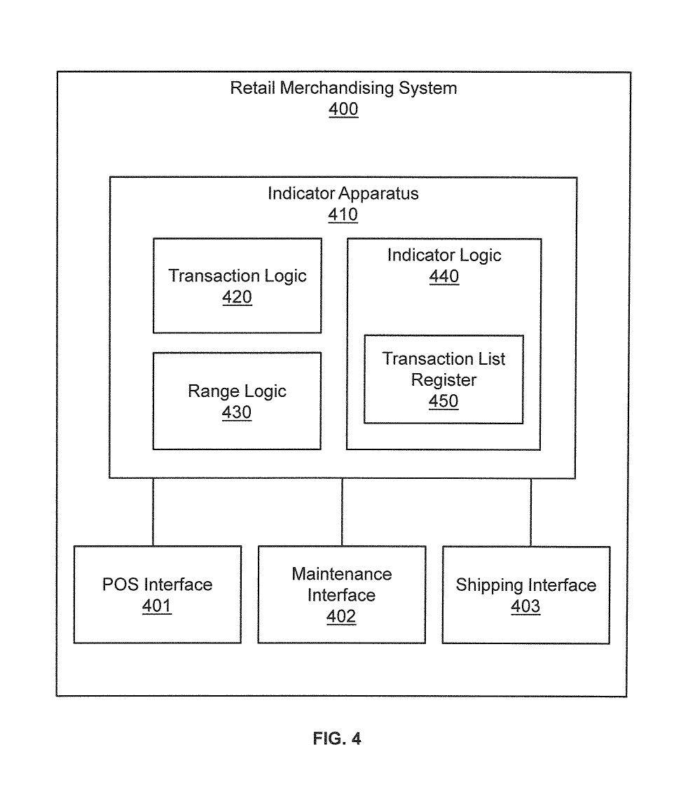

FIG. 4 illustrates one embodiment of a retail merchandising system 400 having an indicator apparatus 410. The indicator apparatus 410 includes a transaction logic 420, a range logic 430, and an indicator logic 440. The indicator logic 440 includes a transaction list register 450.

The retail merchandising system 400 includes interfaces for processing transactions. The interfaces include a point of sale (POS) interface 401, a maintenance interface 402, and a shipping interface 403. The interfaces 401-403 are exemplary of interfaces that would likely be included in a retail merchandising system 400. Additional or different interfaces that facilitate transactional processing for retail enterprises may also be included. The interfaces 401-403 are operably connected to the indicator apparatus 410 to support computer communication between the indicator apparatus 410 and the interfaces 401-403.

The transaction logic 420 identifies a transaction being processed for an item by the retail merchandising system 400 based on the interface used to process the transaction. For example, a transaction involving a return of an item may be initiated at the POS interface 401 (e.g., a checkout register). In one embodiment, the transaction logic 420 identifies the transaction as being a return because the transaction was initiated at the POS interface 401. Additionally or alternatively, the transaction logic 420 may determine the type of transaction based on metadata associated with the transaction.

The range logic 430 determines if the item has been ranged to the location. As described above, if the item has an indicator that is set to intentional or incidental, then a range relationship has been established for the item and location. If the indicator has not been set, then the item has not been ranged to the location.

In the event that the range logic 430 determines that the item has not been ranged to the location, the indicator logic 440 accesses the transaction list register 450 to determine if the transaction has been previously labeled as intentional or incidental. In one embodiment, the transaction list register 450 maintains a list of transactions labeled as intentional and a list of transactions labeled as incidental. The transaction list register 450 is illustrated as being stored locally with the indicator logic 440. However, in another embodiment, the transaction list register 450 is stored in a remote memory accessed by the indicator logic 440.

The indicator logic 440 sets the value of the indicator for the item based on the label of the identified transaction. For example, if the range logic 430 determines that the item is not ranged to the location, the transaction logic 420 determines that the transaction is a return, and the transaction list register 450 has return transactions labeled as incidental, then the indicator logic 440 sets the indicator as incidental to correspond with the label of the transaction.

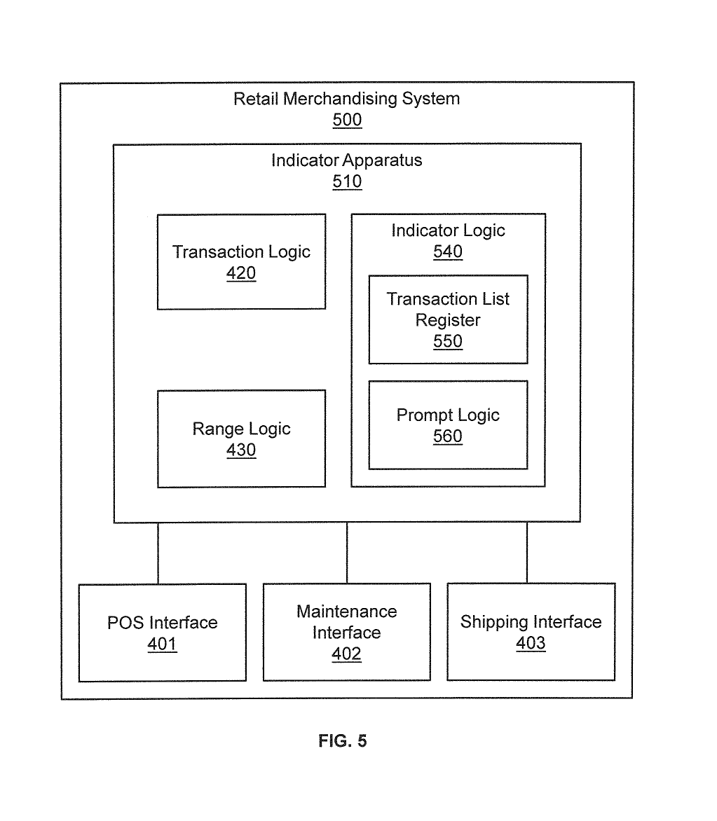

FIG. 5 illustrates retail merchandising system 500 having an indicator apparatus 510 that operates in a similar manner as the merchandising system 400 and indicator apparatus 410 described with respect to FIG. 4. The indicator logic 540 has a transaction list register 550 that operates similarly to the transaction list register 450 that is described in FIG. 4. The indicator logic 540 also includes a prompt logic 560.

In the event that the range logic 430 determines that the item has been ranged to a location, the indicator logic 540 determines whether the indicator of the item was set to incidental. If the indicator was not previously set to incidental, the indicator is maintained as intentional. The indicator of the item is maintained as intentional to support the integrity of the retail plan. In one embodiment, a user can manually change a value of the indicator. In another embodiment, the value of the indicator may be changed by the indicator based on the retail plan.

Conversely, when the indicator of item is set to incidental, the user may desire to change the indicator to intentional if the circumstances at the particular retail location have changed. For example, a retail location may choose to carry an item based on sales of the item at nearby retail locations. When the indicator is set as incidental, the prompt logic 560 prompts the user to determine whether the user wishes to update the value of the indicator to intentional or confirm the value of the indicator as incidental

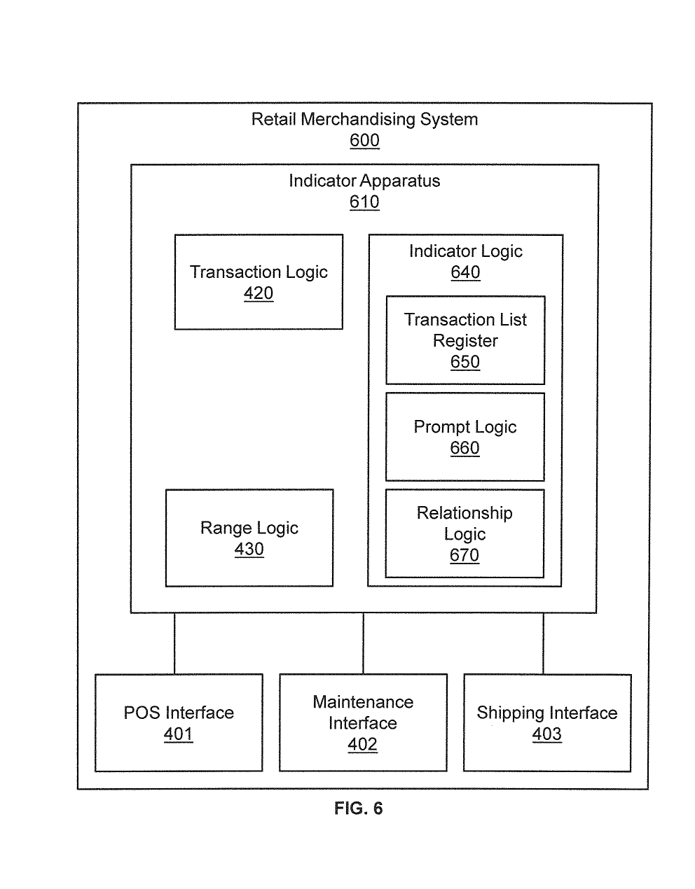

FIG. 6 illustrates retail merchandising system 600 having an indicator apparatus 610 that operates in a similar manner as the merchandising system 500 and indicator apparatus 510, respectively, described with respect to FIG. 5. The indicator logic 640 has a transaction list register 650 and a prompt logic 660 that operate in a similar manner as the transaction list register 550 and prompt logic 560, respectively, that are described in FIG. 5. The indicator logic 640 also includes a relationship logic 670.

When the indicator logic 640 applies a value of incidental or intentional to the indicator of the item, the relationship logic 670 establishes or updates a range relationship for the item and the location. For example, when the range logic 430 determines that the item is not ranged to the location and the transaction list register 650 determines that the transaction associated with item is labeled as incidental, the indicator logic 640 sets the value of the indicator to incidental and the relationship logic 670 establishes a range relationship as incidental. In the future, the range relationship for the item can be accessed as more instances of the item are received by the location. The range relationship reflects whether the item has been intentionally or incidentally ranged to the retail location. By using the range relationship, the indicator logic 640 does not have to determine a value for the indicator based on identifying the transaction and determining if the transaction has been labeled. Instead, an indicator for instances of the item is set based on the existing range relationship for the item. Thus, creating range relationships reduces the amount of processing for future instances of items received at the locations.

When the range logic 430 determines that the item has been ranged to the location as incidental and the prompt logic 660 has received input from a user to update the value of the indicator to intentional, the value of the indicator is updated to intentional at the location. The relationship logic 670 updates the range relationship of the item to reflect that the item has an intentional relationship with the location.

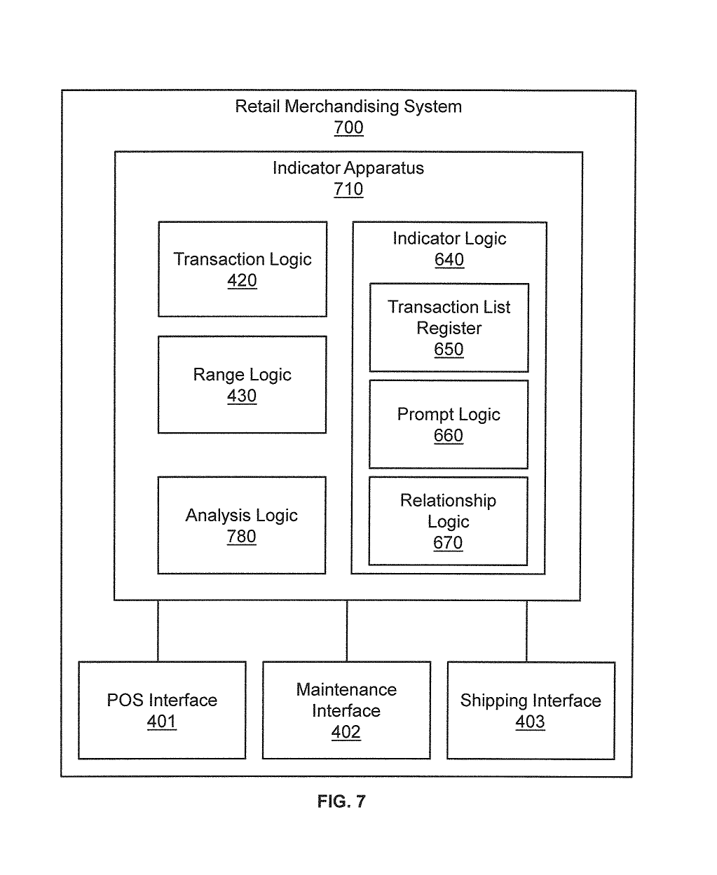

FIG. 7 illustrates one embodiment of a retail merchandising system 700 and indicator apparatus 710 that operate in a similar manner as the retail merchandising system 400 and the indicator apparatus 410, respectively, described in FIG. 4. The indicator apparatus 710 has an analysis logic 780. The analysis logic 780 illustrated an element of indicator apparatus 710, however, in an alternative embodiment, the analysis logic 780 is included in the retail merchandising system 700.

The analysis logic 780 performs analysis based on retail plans. For example, a manager may wish to determine how particular colors of a sweater are selling. In this example, the manager has intentionally stocked red, yellow, and blue sweaters. Therefore, red, yellow, and blue sweaters have indicators set to intentional for the manager's location. Sweaters in other colors have indicators set to incidental.

Sweaters in other colors may be added to the store's assortments because a customer returned a sweater bought at a different location in a color that the manager's store does not stock. Alternatively, a shipping error may have caused a pallet of sweaters in an unstocked color, such as green, to be delivered to the store. The green sweaters would therefore be assigned indicators that indicate that the green sweaters are incidental items.

Because incidental items are not intended to be carried in the store's assortment, including the incidental items in analysis may skew the results. Therefore, the analysis logic 780 removes items having indicators with an incidental value from the data before performing analysis. The analysis logic 780 may include the incidental items at the user's request. For example, if the manager wishes to determine how accepting the green sweaters is affecting the sale of the red, yellow, and blue sweaters in the assortment, the manager may have the analysis logic perform the analysis with the incidental items (e.g., green sweaters).

As can be seen from the foregoing description, the apparatuses and methods are described herein provide an explicit indicator that makes an item identifiable within the operational system as either intentionally or incidentally ranged to a location. This facilitates analysis which supports retail planning and provides more accurate forecasting of incoming and outgoing inventory in a retailer's assortment.

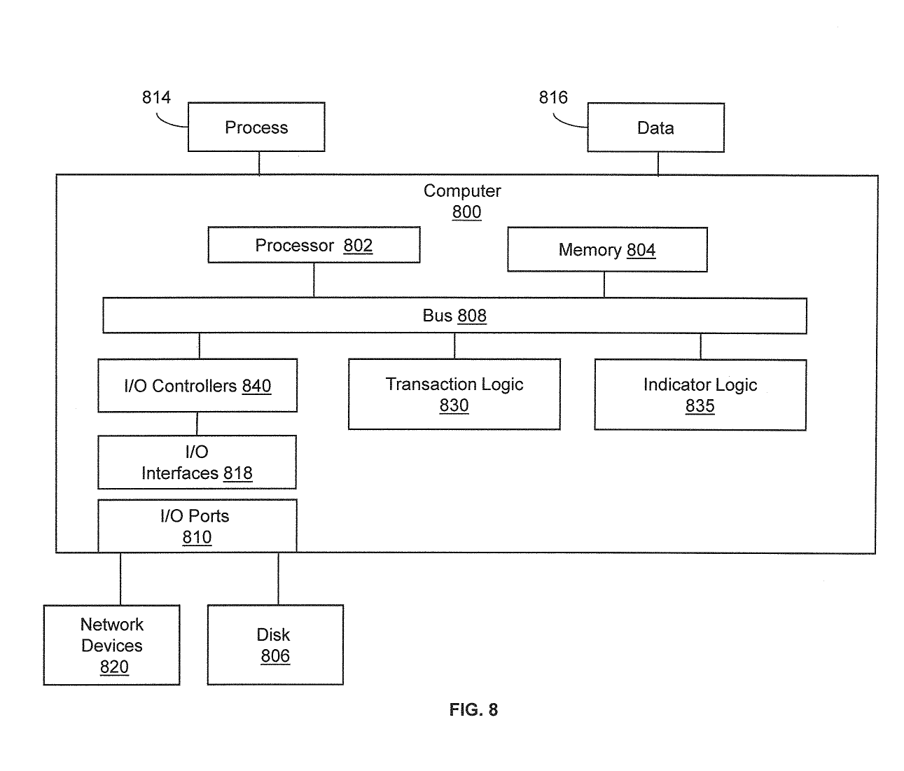

FIG. 8 illustrates an example computing device that is configured and/or programmed with one or more of the example systems and methods described herein, and/or equivalents. The example computing device may be a computer 800 that includes a processor 802, a memory 804, and input/output ports 810 operably connected by a bus 808. In one example, the computer 800 may include a transaction logic 830 configured to facilitate identifying transactions. The transaction logic 830 operates in a similar manner as transaction logic 320 shown in FIGS. 4-7. In different examples, the transaction logic 830 may be implemented in hardware, a non-transitory computer storage medium with stored instructions, firmware, and/or combinations thereof. While the transaction logic 830 is illustrated as a hardware component attached to the bus 808, it is to be appreciated that in one example, the transaction logic 830 could be implemented in the processor 802.

In one embodiment, the transaction logic 830 of the computer 800 is a means (e.g., hardware, non-transitory computer storage medium, firmware) for identifying the type of transaction associated with the item. The means may be implemented, for example, as an ASIC programmed to identify the type of transaction based on the interface used to process the transaction. The means may also be implemented as stored computer executable instructions that are presented to computer 800 as data 816 that are temporarily stored in memory 804 and then executed by processor 802.

In another example, the computer 800 may include an indicator logic 835 configured to facilitate determining whether an item is ranged to a retail location, determining whether the transaction is labeled as incidental or intentional, and setting the value of an indicator for the item to incidental or intentional. The indicator logic 835 operates in a similar manner as the indicator logic 340 shown in FIGS. 3, 4, 5, and 6. In different examples, the indicator logic 835 may be implemented in hardware, a non-transitory computer storage medium with stored instructions, firmware, and/or combinations thereof. While the indicator logic 835 is illustrated as a hardware component attached to the bus 808, it is to be appreciated that in one example, the indicator logic 835 could be implemented in the processor 802.

In one embodiment, the indicator logic 835 of the computer 800 is a means (e.g., hardware, non-transitory computer storage medium, firmware) for whether an item is ranged to a retail location, determining whether the transaction is labeled as incidental or intentional, and setting the value of an indicator for the item to incidental or intentional. The means may be implemented, for example, as an ASIC programmed to set the value of the indicator to incidental or intentional based on whether the identified transaction is labeled as incidental or intentional. The means may also be implemented as stored computer executable instructions that are presented to computer 800 as data 816 that are temporarily stored in memory 804 and then executed by processor 802.

Generally describing an example configuration of the computer 800, the processor 802 may be a variety of various processors including dual microprocessor and other multi-processor architectures. A memory 804 may include volatile memory and/or non-volatile memory. Non-volatile memory may include, for example, ROM, PROM, and so on. Volatile memory may include, for example, RAM, SRAM, DRAM, and so on.

A storage disk 806 may be operably connected to the computer 800 via, for example, an input/output interface (e.g., card, device) 818 and an input/output port 810. The disk 806 may be, for example, a magnetic disk drive, a solid state disk drive, a floppy disk drive, a tape drive, a Zip drive, a flash memory card, a memory stick, and so on. Furthermore, the disk 806 may be a CD-ROM drive, a CD-R drive, a CD-RW drive, a DVD ROM, and so on. The memory 804 can store a process 814 and/or a data 816, for example. The disk 806 and/or the memory 804 can store an operating system that controls and allocates resources of the computer 800.

The computer 800 may interact with input/output devices via the i/o interfaces 818 and the input/output ports 810. Input/output devices may be, for example, a keyboard, a microphone, a pointing and selection device, cameras, video cards, displays, the disk 806, the network devices 820, and so on. The input/output ports 810 may include, for example, serial ports, parallel ports, and USB ports.

The computer 800 can operate in a network environment and thus may be connected to the network devices 820 via the i/o interfaces 818, and/or the i/o ports 810. Through the network devices 820, the computer 800 may interact with a network. Through the network, the computer 800 may be logically connected to remote computers. Networks with which the computer 800 may interact include, but are not limited to, a LAN, a WAN, and other networks.

In another embodiment, the described methods and/or their equivalents may be implemented with computer executable instructions. Thus, in one embodiment, a non-transitory computer storage medium is configured with stored computer executable instructions that when executed by a machine (e.g., processor, computer, and so on) cause the machine (and/or associated components) to perform the methods of FIGS. 1-3.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated. The methods described herein are limited to statutory subject matter under 35 U.S.C §101.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer storage medium”, as used herein, is a non-transitory medium that stores instructions and/or data. A computer storage medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer storage medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read. Computer storage media described herein are limited to statutory subject matter under 35 U.S.C §101.

“Logic”, as used herein, includes a computer or electrical hardware component(s), firmware, a non-transitory computer storage medium that stores instructions, and/or combinations of these components configured to perform a function(s) or an action(s), and/or to cause a function or action from another logic, method, and/or system. Logic may include a microprocessor controlled by an algorithm, a discrete logic (e.g., ASIC), an analog circuit, a digital circuit, a programmed logic device, a memory device containing instructions that when executed perform an algorithm, and so on. Logic may include one or more gates, combinations of gates, or other circuit components. Where multiple logics are described, it may be possible to incorporate the multiple logics into one physical logic component. Similarly, where a single logic unit is described, it may be possible to distribute that single logic unit between multiple physical logic components. Logic as described herein is limited to statutory subject matter under 35 U.S.C §101.

To the extent that the term “includes” or “including” is employed in the detailed description or the claims, it is intended to be inclusive in a manner similar to the term “comprising” as that term is interpreted when employed as a transitional word in a claim.

To the extent that the term “or” is used in the detailed description or claims (e.g., A or B) it is intended to mean “A or B or both”. When the applicants intend to indicate “only A or B but not both” then the phrase “only A or B but not both” will be used. Thus, use of the term “or” herein is the inclusive, and not the exclusive use.

While example systems, methods, and so on have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the disclosure is not limited to the specific details, the representative apparatus, and illustrative examples shown and described. Thus, this application is intended to embrace alterations, modifications, and variations that fall within the scope of the appended claims, which satisfy the statutory subject matter requirements of 35 U.S.C. §101.

What is claimed is:

1. A non-transitory computer storage medium storing instructions for execution by a device, the non-transitory computer storage medium comprising:
instructions configured to identify a transaction associated with an item and a location, where the item has an indicator, the indicator having a value that describes a range relationship between the item and the location, where the indicator has a value of i) incidental when the item is not stocked by the location and ii) intentional when the item is stocked by the location, further where the indicator of the item is not set when a range relationship has not been established between the item and the location;
instructions configured to, when the indicator of the item has not been set:
determine if the transaction has been labeled as incidental or intentional; and
set the value for the indicator of the item to the label of the transaction.

2. The non-transitory computer storage medium of claim 1, further comprising instructions configured to label the transaction as incidental if the transaction causes the item to be introduced into a retail assortment of the location and the location is not intended to carry the item.

3. The non-transitory computer storage medium of claim 1, further comprising instructions configured to label the transaction as incidental if the transaction is a return of the item to the location, an unexpected receipt of an item on transfer, an unexpected receipt of the item on a purchase order, an unexpected receipt of the item on allocation, a purchase order established in-store, or a transfer established in store or warehouse systems.

4. The non-transitory computer storage medium of claim 1, further comprising instructions configured to label the transaction as intentional if the transaction causes the item to be introduced into a retail assortment of the location and the location is intended to carry the item.

5. The non-transitory computer storage medium of claim 1, further comprising instructions configured to label the transaction as intentional if the transaction is an on-line purchase order, an external purchase order, an on-line transfer inbound, an external transfer inbound, or an online manual item.

6. The non-transitory computer storage medium of claim 1, further comprising instructions configured to label the transaction as incidental or intentional based, at least in part, on an interface used to process the transaction.

7. The non-transitory computer storage medium of claim 6, further comprising instructions configured to label the transaction as incidental when the interface is a point of sale device.

8. The non-transitory computer storage medium of claim 1, further comprising instructions configured to establish a range relationship between the item and the location based, at least in part on the value of the item's indicator.

9. The non-transitory computer storage medium of claim 1, further comprising instructions configured to:
determine whether a range relationship has been established for the item; and
set the value of the indicator based, at least in part, on the range relationship.

10. A computing system, comprising:
transaction logic configured to identify a transaction associated with an item and a location, where the item has an indicator, the indicator having a value that describes a range relationship between the item and the location, where the indicator has a value of i) incidental when the item is not stocked by the location and ii) intentional when the item is stocked by the location, further where the indicator of the item is not set when a range relationship has not been established between the item and the location;
range logic configured to determine if the transaction has been labeled as incidental or intentional;
indicator logic configured to set the value for the indicator of the item to the label of the transaction.

11. The computing system of claim 10, further comprising prompt logic configured to prompt a user to confirm or update the value of the item's indicator.

12. The computing system of claim 10, further comprising relationship logic configured to establish a range relationship for the item and the location based, at least in part, on the value of the indicator.

13. The computing system of claim 10, further comprising analysis logic configured to:
access a corpus of data;
identify, in the corpus of data, data corresponding to items having indicators with a value of incidental;
remove the identified data to create input data; and
perform retail planning analysis on the input data.

14. The computing system of claim 13, where the analysis logic is further configured to:
receive a request to include items having indicators with the value of incidental in the retail planning analysis; and
perform the retail planning analysis on the corpus of data.

15. A method comprising:
identifying a transaction associated with an item and a location, where the item has an indicator, the indicator having a value that describes a range relationship between the item and the location, where the indicator has a value of i) incidental when the item is not stocked by the location and ii) intentional when the item is stocked by the location, further where the indicator of the item is not set when a range relationship has not been established between the item and the location;
determining that the transaction has been labeled as incidental or intentional when the indicator of the item has not been set; and
setting the value for the indicator of the item to the label of the transaction.

16. The method of claim 15, further comprising maintaining the value of the indicator as intentional when the indicator is set to intentional.

17. The method of claim 16, further comprising, when the indicator is set to incidental:
prompting a user to change the indicator to intentional or to confirm the indicator as incidental; and
maintaining the value of the indicator as incidental when the user confirms the indicator as incidental.

18. The method of claim 16, further comprising, when the indicator is set to incidental:
prompting a user to change the indicator to intentional or to confirm the indicator as incidental; and
updating the value of the indicator to intentional when the user changes to the indicator to intentional.

19. The method of claim 15, further comprising:
comparing the identified transaction to a list of labeled transactions to determine whether the transaction has been labeled as incidental or intentional.

20. The method of claim 15, further comprising:
creating a range relationship between the item and the location based, at least in part on the value of the item's indicator.
